(19) United States
(12) Patent Application Publication
(10) Pub. No.: US 2023/0059295 A1
(43) Pub. Date: Feb. 23, 2023

(54) WAREHOUSE VEHICLE HAVING A TRACKED DRIVE

(71) Applicant: WITRON LOGISTIK + INFORMATIK GMBH, Parkstein (DE)

(72) Inventor: Patrick ZEIS, Parkstein (DE)

(21) Appl. No.: 17/759,936

(22) PCT Filed: Jan. 21, 2021
(86) PCT No.: PCT/EP2021/051258

§ 371 Date: Aug. 2, 2022

(30) Foreign Application Priority Data
Feb. 4, 2020 (DE) 10 2020 102 828.8

(51) Int. Cl. B66F 9/07

(52) U.S. Cl. CPC B66F 9/072

(57) ABSTRACT

Warehouse vehicle, which can be moved along a guide rail (40) provided with engagement elements (43), the vehicle comprising running gear (30) and a drive unit (20) connected to the running gear (30). The drive unit (20) comprises a drive wheel (21) which is coupled to a drive motor and has circumferential engagement elements; and a continuous drive belt (25) which is provided with engagement elements; and a guide roller assembly (22, 24, 24a) for guiding the continuous drive belt (25), which guide roller assembly is configured such that the continuous drive belt (25) can be brought into engagement with the drive wheel (21) and with the engagement elements (43) of the guide rail (40) in order to drive the warehouse vehicle. The warehouse-vehicle drive according to the invention allows high acceleration values and thus a high level of performance of the warehouse vehicle.

### FIELD OF THE INVENTION

The invention relates to a drive for vehicles to be used in warehouses, such as for example stacker cranes for moving items in and out of shelf warehouses.

### BACKGROUND OF THE INVENTION

Such stacker cranes take on for example the loading and removal of goods into and out of a high bay warehouse. For this, the stacker crane drives into the shelf warehouse, up to the respective storage positions, and removes or loads the respective goods. The performance, i.e. the goods throughput of such a shelf warehouse, depends crucially on the speed and in particular the possible maximum acceleration of the stacker cranes or other warehouse vehicles. In particular for vehicles with high unladen weight or high payloads, this places major requirements on the drive technology of the warehouse vehicles.

Predominantly, two different drive variants are used in traction drive technology for warehouse vehicles:

With friction drive, the dead weight of the vehicle generates the downforce between drive wheel and driving surface. By means of this downforce, an advancing force can be generated by the drive wheel on the driving surface in order to accelerate the vehicle, due to the friction between drive wheel and driving surface. The amount of contribution from acceleration or deceleration depends accordingly on the friction coefficient of drive wheel/driving surface. Due to the connection, actuated by adherence, between frictional wheel and driving surface (similar to a motor vehicle on the road), only relatively low torques can be transmitted, and thus only comparatively small accelerations or decelerations can be achieved.

With rack-and-pinion drive, a rack is used along the entire length of the travelling distance of the vehicle. Using a driving toothed wheel (pinion) engaging in the rack, which driving toothed wheel is connected to the running gear of the warehouse vehicle, the rotational movement of the driven wheel is converted into a translational movement. High torques can be transmitted with the rack-and-pinion drive, and therefore high accelerations and decelerations can be achieved. However, the high maintenance costs (lubrication) and high noise development as well as the comparatively high installation costs are disadvantageous. Therefore, the problem of the present invention is to propose a drive concept for a warehouse vehicle which makes possible high acceleration and deceleration values and simultaneously low maintenance and installation costs of the drive elements.

### SUMMARY OF THE INVENTION

The problem is solved by the warehouse vehicle according to the invention, described in claim 1, which vehicle can be moved along a guide rail provided with engagement elements, the vehicle comprising a running gear and a drive unit connected to the running gear. The drive unit has a drive wheel coupled to a drive motor and having circumferential engagement elements, a continuous drive belt provided with engagement elements, and a guide roller assembly for guiding the continuous drive belt, which guide roller assembly is designed such that the continuous drive belt can be brought into engagement both with the drive wheel and with the engagement elements of the guide rail to guide the warehouse vehicle. The engagement elements or teeth of the continuous drive belt are engaged with the engagement elements of the guide rail over a greater distance, as are the engagement elements of the drive wheel with those of the continuous drive belt. Therefore, the drive force is distributed over a plurality of pairs of engagement elements.

The drive according to the invention thus makes possible high acceleration and deceleration values in both directions of motion even with heavy loads, and thus enables high performance of the warehouse vehicle, with simultaneously low maintenance costs and low noise development.

Preferably, the continuous drive belt is guided, in omega geometry, about the drive wheel and the guide roller assembly such that the engagement elements engage, on the same side of the continuous drive belt, both with the drive wheel and also with the guide rail provided with engagement elements. The omega geometry makes possible a “compact” construction of the drive.

The guide roller assembly comprises preferably two guide rollers on the guide rail side, and two guide rollers facing away from the guide rail, wherein at least one of the guide rollers can be designed as a tensioning roller for tensioning the continuous drive belt.

Furthermore, the drive unit can have pressing elements, preferably draw rollers, for pressing the continuous drive belt against the guide rail provided with engagement elements.

The continuous drive belt can be made of an elastic material such as plastic or rubber material, preferably polyurethane. Using a NFC textile can further reduce noise development. The warehouse vehicle preferably has guide rollers for maintaining a defined distance between drive unit and guide rail.

The drive unit can have one or more drive motors which is/are coupled to the axle of the drive wheel via a belt drive. In so doing, by choosing a suitable diameter of the belt pulleys, the belt drive can have a step up or step down, and thus serve as a gearing mechanism. A gearing mechanism which is flange-connected to the drive motor may then be dispensed with, as a result of which a considerable saving on weight can be made.

Alternatively, the drive motor can be arranged separately from the drive unit.

The running gear of the warehouse vehicle preferably has a running gear body as well as one or more running wheels.

The invention also relates to a warehouse vehicle system having a guide rail provided with engagement elements, as well as a warehouse vehicle according to the invention which can be moved along the guide rail.

The engagement elements of the guide rail can be formed by toothed belts attached to same. The toothed belts can be made of elastic material, preferably polyurethane. Here, too, NFC textile can be used to reduce noise development. The toothed belts are preferably fixed to the guide rail at specific distances.

The invention also relates to warehouses which have one or more warehouse vehicle systems according to the invention, wherein the guide rails are arranged in longitudinal and/or transverse direction or even in vertical direction corresponding to a direction of motion of the respective warehouse vehicle.

### DESCRIPTION OF THE FIGURES

The invention is described below in detail with the help of embodiment examples, with reference to the drawings. There are shown in:

FIG. 1 a schematic, perspective representation of a first embodiment example of the running gear of a warehouse vehicle according to the invention, without drive element;

FIG. 2 a schematic, horizontal sectional view of the drive element of the first embodiment example of the warehouse vehicle according to the invention;

FIG. 3 a schematic, perspective representation of the drive element according to FIG. 2;

FIG. 4 a schematic, detailed representation of the drive element according to FIG. 2;

FIG. 5 a schematic horizontal sectional view of the drive element of a second embodiment example of the warehouse vehicle according to the invention;

FIG. 6 a schematic, perspective representation of the drive element according to FIG. 5; and

FIG. 7 a schematic, perspective representation of the drive element of a third embodiment example of the warehouse vehicle according to the invention.

### DETAILED DESCRIPTION OF THE INVENTION

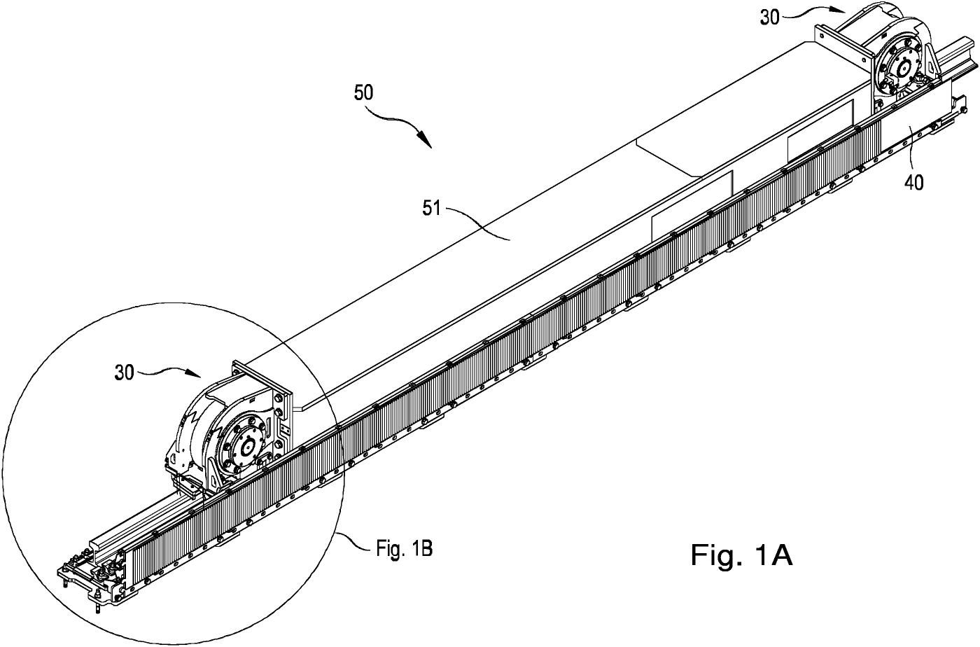

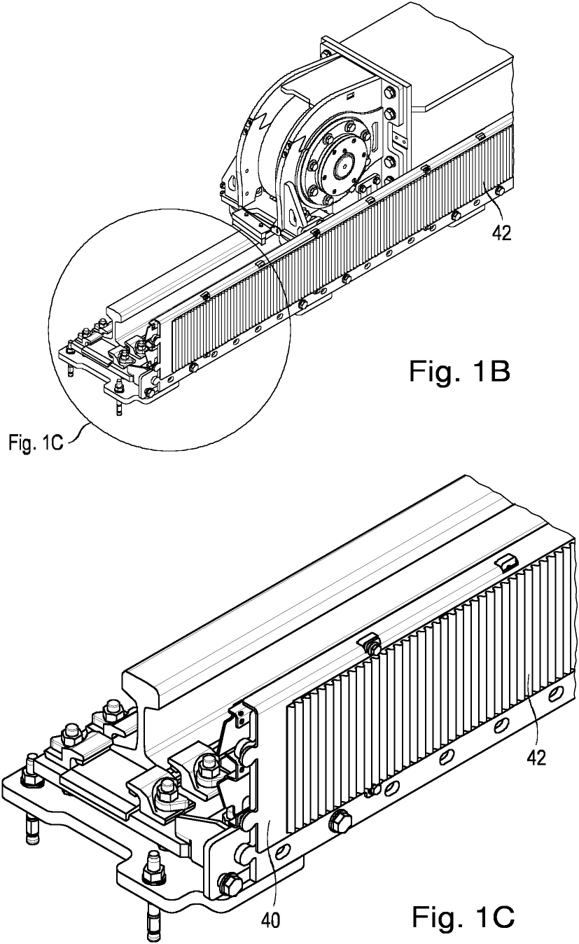

FIGS. 1-4 show a first embodiment example of the warehouse vehicle according to the invention. FIG. 1A shows a schematic, perspective representation of running gear 50 of the embodiment example of a warehouse vehicle according to the invention. The warehouse vehicle can carry out any functions within a warehouse and have corresponding superstructure and handling elements which are not represented here and are independent of the invention. For example, the warehouse vehicle can be used as a stacking vehicle for loading and removal of goods from a high bay warehouse or even as cross conveyor for connecting different conveyor technique elements such as roller conveyors or conveyor belts. The invention relates to the drive of the warehouse vehicle, which can fulfil the most varied functions.

Wheelmounts are mounted either side of running gear 50 of the embodiment example shown in FIG. 1, which wheelmounts contain running wheels 30. These serve to guide the warehouse vehicle through the aisles of racks. However, other wheel arrangements are likewise possible.

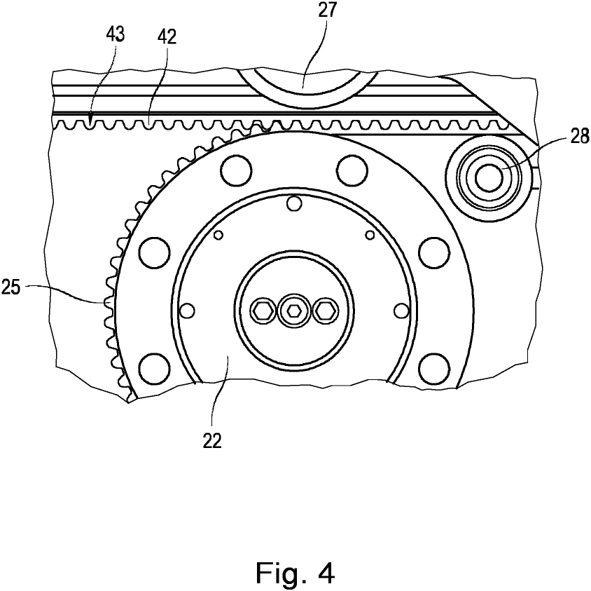

Furthermore, the guide rail 40, arranged stationary in the warehouse building, and defining the guideway of the warehouse vehicle, is shown in FIG. 1. As can be seen in particular in the detailed representations of FIGS. 1B and 1C, a toothed belt 42 with engagement elements (teeth) 43 is attached to guide rail 40 (cf. FIG. 4). Toothed belt 42 is preferably made of elastic material such as plastic or rubber material, in particular polyurethane, and fixed to guide rail 40 at specific distances, forming with same a fixed unit. This unit is preferably installed over the entire length of the aisle/driving surface of the warehouse and can be fixed to the floor by means of a rail foot or the like. Compared with a rack, toothed belt 42 fixed to a guide rail 40 has the further advantage of clearly lower installation cost, as several rack elements assembled in a row need to be aligned very precisely with one another, which means high manufacturing costs. This cost is dispensed with when using a toothed belt.

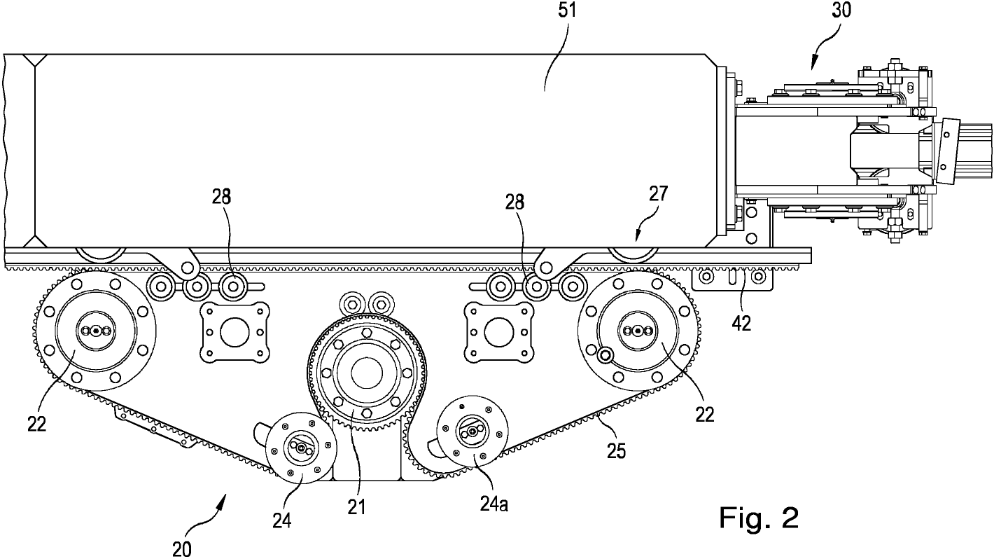

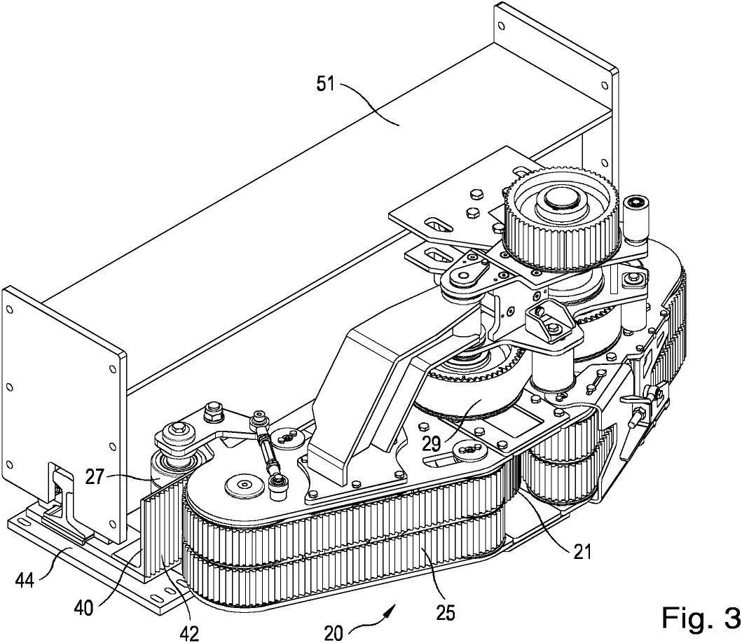

FIG. 2 shows a schematic horizontal sectional view and FIG. 3 a perspective view of the drive unit 20, which accelerates and drives the warehouse vehicle on the guideway. Part of running gear body 51 and part of one of the running wheels 30 is visible in the upper part of FIG. 2.

The engagement elements (teeth) of a continuous drive belt 25 engage in the toothed belt 42, which belt, in the shown embodiment example, is guided in an omega geometry about an arrangement of guide rollers 22, 24, 24a and a drive wheel or drive disk 21 likewise provided with engagement elements (teeth). The tooth side of the continuous drive belt 25 is inserted into the toothed belt 42. One or more guide rollers is/are designed movable as tensioning roller(s) 24a, for setting a suitable tension of continuous drive belt 25.

The drive wheel 21 is coupled to an electric motor or another suitable drive unit. Due to the omega geometry, the engagement elements of drive wheel 21 engage with the engagement elements of the continuous drive belt 25 over a considerable part of the circumference of drive wheel 21, with the result that good transmission of power from drive wheel 21 to continuous drive belt 25 at low maintenance cost is ensured.

Drive unit 20 is preferably fixedly connected to running gear body 51 of the warehouse vehicle, and can be released from this by removing various components. Drive unit 20 is kept at a constant distance from running gear body 51 by means of a guide roller 27, which is visible in particular in FIGS. 3 and 4, with the result that good engagement of the engagement elements of continuous drive belt 25 in the corresponding engagement elements of toothed belt 42 is possible. Furthermore, draw rollers 28 are provided, which ensure the contact pressure of continuous drive belt 25 on toothed belts 42, required for transmission of power. As transmission of power from continuous drive belt 25 onto toothed belts 42 is distributed over a plurality of pairs of engagement elements, the force, and thus wear, on the individual engagement element, is reduced. As a result, noise-reducing materials, such as for example polyurethane and also NFC textile, can also be used for drive wheel 21, continuous drive belt 25 and also toothed belts 42. Toothed belt 42 discharges the force into the ground via guide rail 40 and the floor connection.

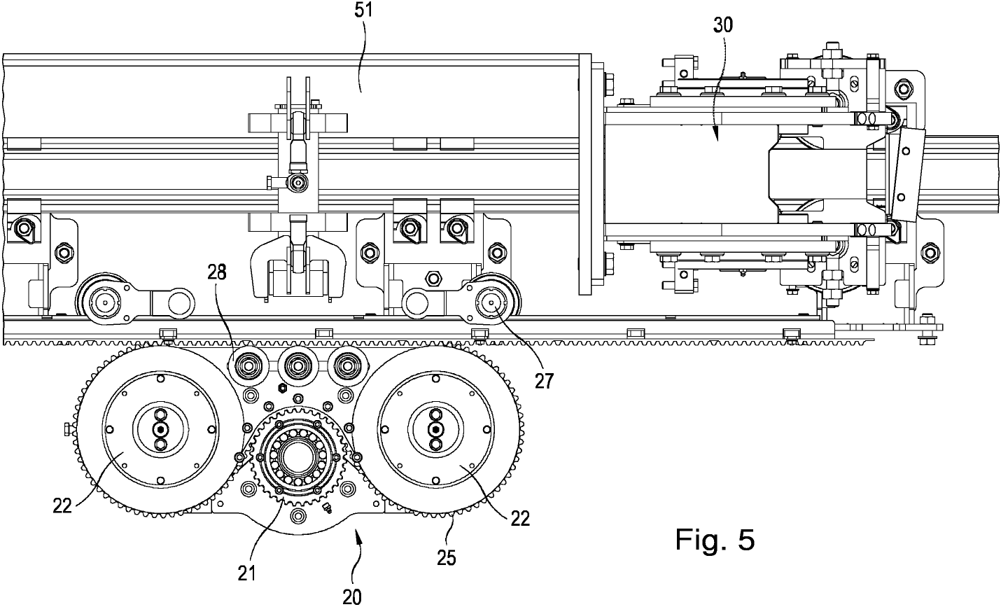

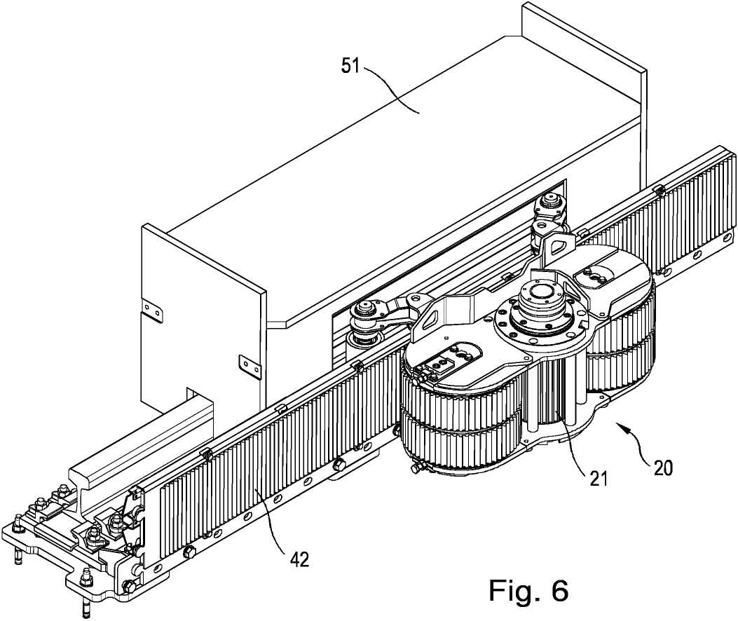

FIGS. 5 and 6 show a second embodiment example of drive unit 20 of the warehouse vehicle according to the invention. The functionality of the second embodiment example corresponds substantially to that of the first embodiment example, but is characterised by a particularly compact construction.

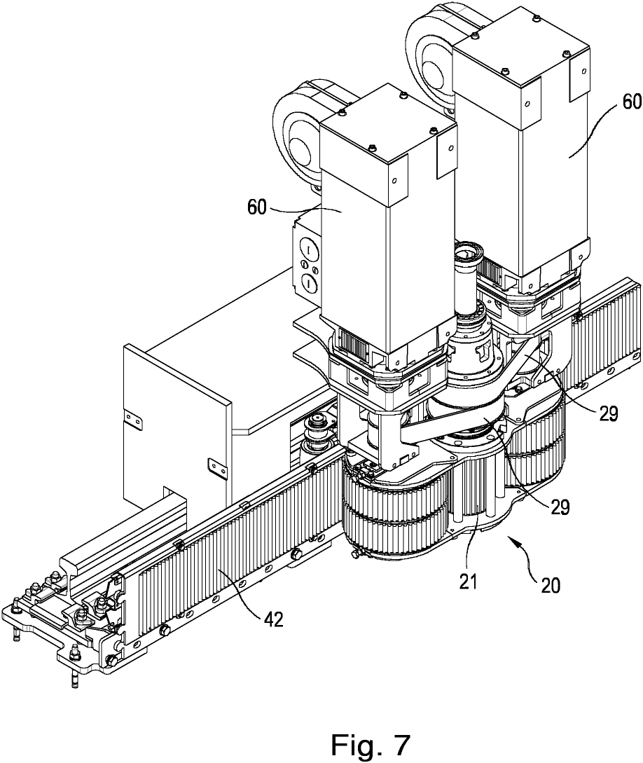

FIG. 7 in turn shows a third embodiment example of drive unit 20 of the warehouse vehicle according to the invention, based on the second embodiment example, but differing therefrom in that two drive motors 60 are attached directly to the drive unit. In so doing, the drive force is transmitted from the motors 60 to the drive shaft of drive wheel 21 via belt drive 29. By selecting a suitable diameter of the belt pulleys, a suitable step up or step down can be chosen between drive motors 60 and drive wheel 21. In this way, the belt drive can serve simultaneously as gearing mechanism, whereby a heavy and bulky motor gearing mechanism can be dispensed with.

The warehouse vehicle according to the invention thus makes possible rapid accelerations and decelerations in both directions of motion, even with heavy loads, and thus improved performance of the respective warehouse. The warehouse vehicle can be used by being moved along the aisles of racks, or even as a cross conveyor transverse to the direction of the aisles of racks, or for connecting different conveyor technique elements such as roller conveyors or conveyor belts. Moreover, the drive according to the invention can be used to drive vertical conveyors.

1-15. (canceled)

16. A warehouse vehicle, wherein the vehicle can be moved along a guide rail provided with engagement elements and comprises a running gear and a drive unit connected to the running gear, the drive unit comprising:
a drive wheel coupled to a drive motor and having circumferential engagement elements,
a continuous drive belt provided with engagement elements,
a guide roller assembly for guiding the continuous drive belt, which guide roller assembly is configured such that the continuous drive belt can be brought into engagement both with the drive wheel and with the engagement elements of the guide rail to drive the warehouse vehicle.

17. The warehouse vehicle of claim 16, wherein the continuous drive belt is guided, in omega geometry, about the drive wheel and the guide roller assembly such that the engagement elements engage, on the same side of the continuous drive belt, both with the drive wheel and also with the guide rail provided with engagement elements.

18. The warehouse vehicle of claim 17, wherein the guide roller assembly comprises two guide rollers on a guide rail side, and two guide rollers facing away from the guide rail.

19. The warehouse vehicle of claim 18, wherein at least one of the guide rollers is designed as displaceable tensioning roller for tensioning the continuous drive belt.

20. The warehouse vehicle of claim 19, wherein the vehicle further comprises pressing elements for pressing the continuous drive belt against the guide rail provided with engagement elements.

21. The warehouse vehicle of claim 20, wherein the pressing elements are designed as draw rollers.

22. The warehouse vehicle of claim 16, wherein the vehicle further comprises one or more guide rollers for maintaining a defined distance between the drive unit and the guide rail.

23. The warehouse vehicle of claim 16, wherein the continuous drive belt is made of elastic material.

24. The warehouse vehicle of claim 23, wherein the continuous drive belt is made of polyurethane.

25. The warehouse vehicle of claim 16, wherein the drive unit comprises at least one drive motor which is coupled to an axle of the drive wheel via a belt drive.

26. The warehouse vehicle of claim 25, wherein the belt drive effects a step up or step down of a drive force.

27. The warehouse vehicle of claim 22, wherein the drive unit comprises at least one drive motor which is coupled to an axle of the drive wheel via a belt drive.

28. The warehouse vehicle of claim 16, wherein the running gear comprises a running gear body and one or more running wheels.

29. The warehouse vehicle of claim 27, wherein the running gear comprises a running gear body and one or more running wheels.

30. A warehouse vehicle system, wherein the system comprises a guide rail provided with engagement elements as well as the warehouse vehicle of claim 16 which can be moved along the guide rail.

31. The warehouse vehicle system of claim 30, wherein the engagement elements are formed by toothed belts attached to the guide rail.

32. The warehouse vehicle system of claim 31, wherein the toothed belts are made of elastic material and are fixed, spaced apart, to the guide rail.

33. The warehouse vehicle system of claim 32, wherein the toothed belts are made of polyurethane.

34. A warehouse, wherein the warehouse comprises one or more warehouse vehicle systems according to claim 30, the guide rails being arranged in longitudinal and/or transverse direction or being also arranged in vertical direction according to a direction of motion of a respective warehouse vehicle.
